(19) United States
(12) Patent Application Publication
(10) Pub. No.: US 2003/0098791 A1
(43) Pub. Date: May 29, 2003

(54) Wireless security sensor systems for windows and doors

(76) Inventors: Julian Carlson, Blaine, WA (US); Dean David Schebel, Port Coquitlam (CA)

Correspondence Address: Ralph A. Dowell, Dowell & Dowell, P.C., Suite 309, 1215 Jefferson Davis Highway, Arlington, VA, 22202, US

(21) Appl. No.: 09/994,048

(22) Filed: Nov. 27, 2001

(51) Int. Cl. G08B 13/08

(52) U.S. Cl. 340/547; 340/539.1

(57) ABSTRACT

An wireless security sensor system includes a window frame defining a window opening, a window sash movable relative to the window frame between open and closed positions; and a sensor unit embedded in the window frame. The sensor unit includes a housing having an inner end within the window frame, an outer end at a surface of the window frame and a flexible ¼ wave wire antenna extending e.g. longitudinally of the window frame from the housing. The housing contains a sensor switch, a microprocessor, and RF transmitter and a battery for emitting signals to a master station or controller and the wireless security sensor system includes a magnet mounted in the window sash for actuating the sensor switch. The window frame is made from a plastics material extrusion having a hollow interior and the housing has a peripheral flange at the outer end thereof which is seated on the surface of the window frame.

### BACKGROUND OF THE INVENTION

1. Field of the Invention

The present invention relates to wireless security sensor systems and, more particularly, to wireless security sensor systems, for installation in doors and/or windows, of the type employing RF transmitters for emitting radio frequency signals.

2. Description of the Related Art

Wireless security systems allow a residence or business to be monitored without a need for extensive wiring throughout the residence or building, and therefore have the advantages that they require lower installation costs and lower product costs and provide an easier upgrade path for possible future improvements than prior systems requiring such wiring.

Prior wireless security sensor systems communicate a disturbance to a master station or a controller and monitor, typically located within the same building as the wireless security system, on a common radio frequency and usually comprise a housing containing a battery, a microprocessor, an RF transmitter and an antenna. These prior systems are designed to be installed into a building after the construction of the building has been completed, by being mounted on the surface of a window sash or door or by drilling into a door or door frame.

In order to provide a sufficient transmission range, to report reliably to the master station or controller, the components within the housing, and in particular the antenna, must be of sufficient size. Consequently, the housing is bulky and, when surface mounted, is clearly and unattractively visible. When a sufficiently lengthy hole is required to be drilled into a door frame to accommodate the housing, there is a risk of defects such as water damage.

### BRIEF SUMMARY OF THE INVENTION

It is accordingly an object of the present invention to provide an improved wireless security sensor system employing a sensor unit having a substantially more compact housing than has previously been possible and which, therefore, presents a substantially less intrusive appearance than prior alarm sensor units.

According to the present invention, there is provided an wireless security sensor system which comprises a frame defining a opening, with closure movable relative to the frame between open and closed positions. A sensor unit is embedded in the frame comprises and a housing having an inner end within the frame, an outer end at the opening and an antenna extending from the housing at the exterior of the housing. The housing also contains a sensor switch, a microprocessor, and RF transmitter and a battery. A magnet is mounted in the closure for actuating the sensor switch.

Since the antenna does not have to be accommodated within the housing, the housing can be made substantially smaller than has been possible with prior art alarm sensor unit housings. Therefore the sensor unit can be almost entirely embedded in, for example, a window sash or frame or in a small boring in a door. Consequently, the sensor unit can be so effectively concealed that it is not only unobtrusive but effectively almost invisible.

The use of a wire antenna has the further advantage that it enables the sensor unit to be designed so as to conserve power and therefore so as to require smaller batteries than have been required in prior art sensor units.

Preferably, the antenna is in the form of a flexible wire, which can be conveniently bent, as required, in order to adapt it to the frame.

The frame may be a window frame or a door frame, the closure correspondently being a window sash or a door.

The frame may, for example, be in the form of an extrusion, for example a vinyl extrusion, having a hollow interior. In that case, the wire can be positioned, during the installation of the sensor unit into the frame, so that the antenna extends longitudinally along the hollow interior of the frame.

### BRIEF DESCRIPTION OF THE DRAWINGS

The present invention will be more readily understood from the following description of a preferred embodiment thereof given, by way of example, with reference to the accompanying drawings, in which:

FIG. 1 shows a broken-away view, in perspective, of parts of a window frame and a window sash in which a wireless security sensor system embodying the present invention is installed;

FIG. 2 shows a view in front elevation of the window sash and the window frame of FIG. 1;

FIG. 3 shows a view in front elevation, corresponding to FIG. 2, but with the window sash moving upwardly away from its closed position relative to the window frame;

FIG. 4 shows a block diagram of the electronic components of a sensor unit embedded in the window frame of FIGS. 1 through 3;

FIG. 5 shows a few in fund elevation of a window sash and a window frame, similar to that of FIG. 2, but with a sensor unit embedded in the side of the window frame;

FIG. 6 shows a broken-away view in front elevation of parts of a wooden window and window frame; and

FIG. 7 shows a broken-away view, in front elevation, of parts of a wooden door and door frame.

### DESCRIPTION OF THE PREFERRED EMBODIMENT

In the accompanying drawings, reference numeral 10 indicates generally a part of a window frame defining a window opening and reference numeral 12 indicates generally a part of a window sash which is movable to and fro, between open and closed positions, relative to the window frame 10.

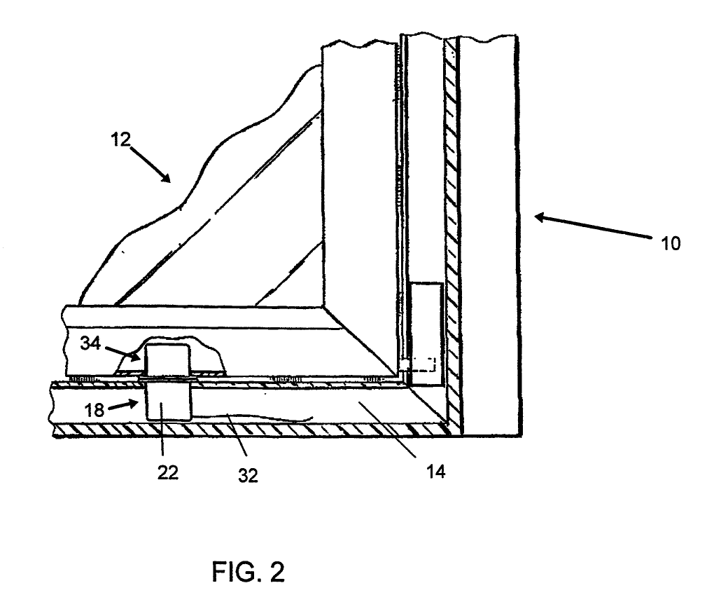

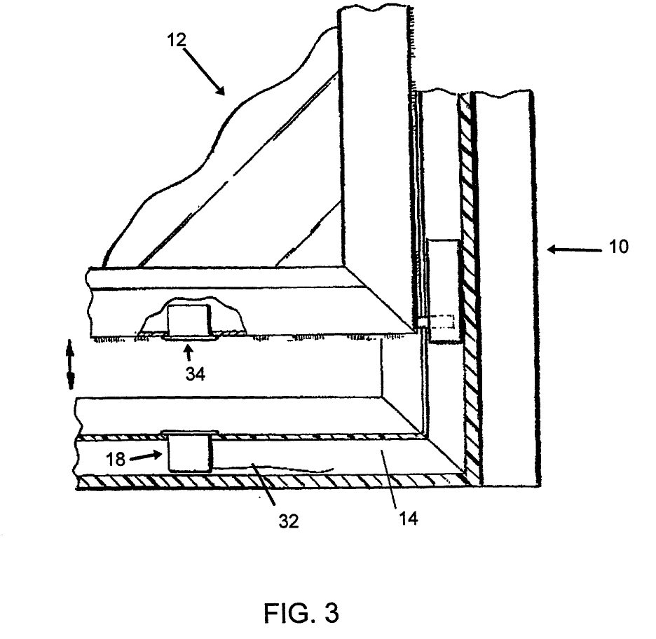

The window frame 10 is made from an extrusion of a vinyl material which, with reference in particular to FIGS. 2 and 3, has a hollow interior 14 extending along the length of the extrusion.

The window sash 12 is also formed from an extrusion of vinyl material having a hollow interior 16.

A sensor unit indicated generally by reference numeral 18 is provided in the window frame 10. The sensor unit 18 has a cylindrical housing 22 having an inner end 24 within the hollow interior 14 and an outer end 26 in the form of a disk forming a peripheral flange 28 around the cylindrical housing 22. The peripheral flange 28 is seated on an upper wall 30 of the vinyl extrusion of the window frame 10 and the inner end 24 is inserted through a circular opening in the wall 30 into the hollow interior 14. Since the flange 28 is thin, and the top or upper end of the housing 22 is therefore almost flush with the surface numeral 30, the sensor unit 18 is almost invisible when thus installed in the window frame 10. Therefore, the sensor unit 18 is accommodated in an extremely unobtrusive manner in the vinyl extrusion of the window frame 10.

Furthermore, if the sensor unit 18 is installed in the window frame 10 at a factory where the window frame is manufactured, the sensor unit 18 is protected by the window frame against damage during subsequent possible rough handling of the window frame 10 during packaging, transportation, storage, unpacking and on site installation of the window frame 10.

A ¼ wave wire antenna 32 extends from the housing 22 longitudinally along the hollow interior 14 of the window frame extrusion. The provision of the antenna 32 at the exterior of the cylindrical housing 22 substantially facilitates the objective of keeping the length of the latter extremely small. Therefore, it is possible to accommodate the sensor device 18 within the relatively shallow height of the hollow interior 14 of the window frame extrusion. Furthermore, it is consequently also possible to install the sensor unit 18 at any convenient location around the window opening.

Within the hollow interior 16 of the window sash extrusion, there is similarly embedded a magnet indicated generally by reference numeral 34, which is accommodated within a cylindrical housing 36.

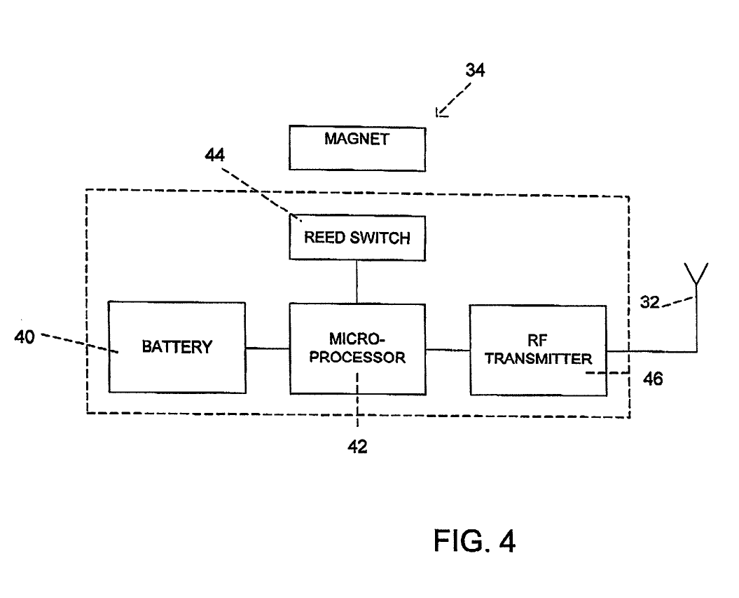

Referring now to FIG. 4 of the accompanying drawings, which shows a block diagram of the sensor unit 18, and the magnet 54, it can be seen that the sensor unit 18 has a battery 40 for energizing a microprocessor 42, a reed switch 44 and an RF transmitter 46, which outputs a radio signal to the antenna 32. The reed switch 44 is actuated by the magnet 34, on displacement of the window sash 12 relative to the window frame 10, and in response to the actuation of the reed switch 44 the microprocessor 42 causes a signal to be transmitted by the RF transmitter 46 from the antenna 32.

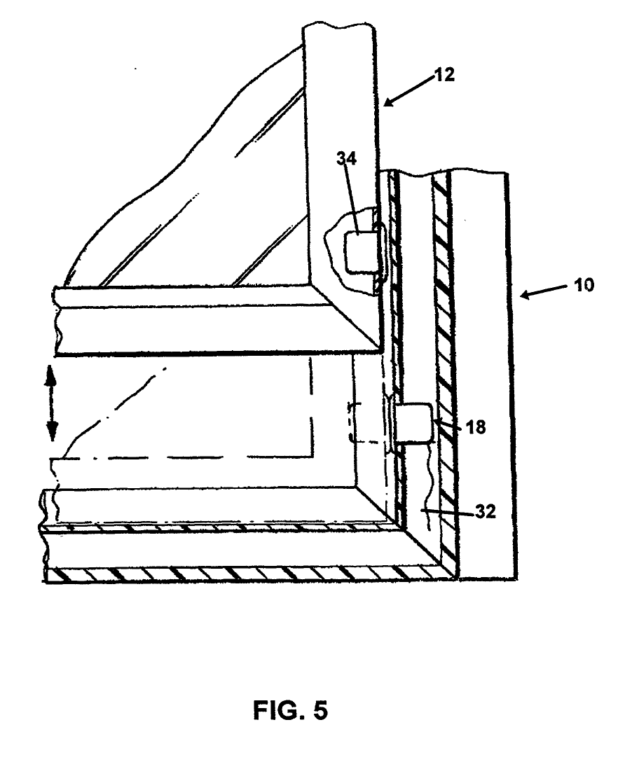

In FIG. 5, the sensor unit 18 is shown embedded in one side of the window frame 10, instead of in the bottom of the window frame as in FIG. 2, with the wire antenna 32 extending downwardly along the interior of the window frame 10, and the magnet 34 is correspondingly embedded in an adjacent side of the window sash 12.

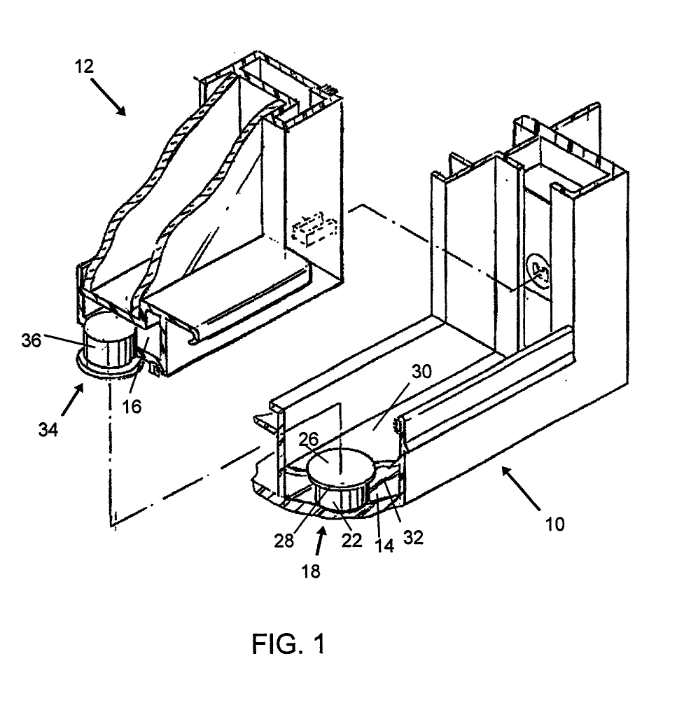

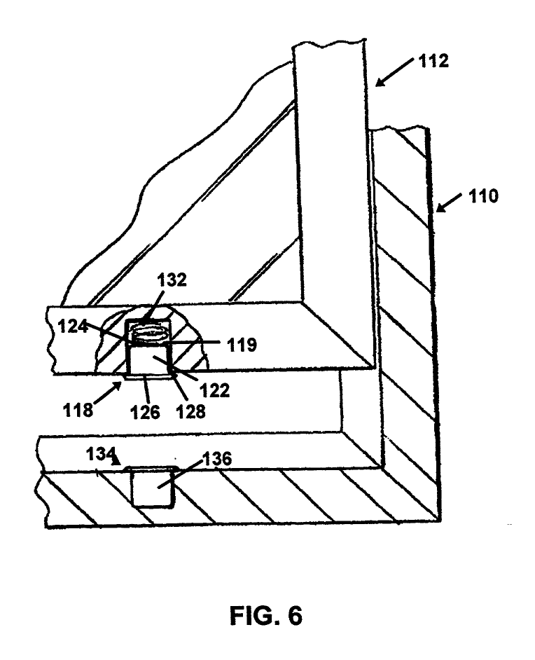

In FIG. 6, parts of a window and a window frame which correspond to those of the window and window frame of FIGS. 1 to 3, have been indicated, for convenience, by corresponding reference numerals increased by 100.

FIG. 6 shows a part of a window frame indicated generally by reference to 110, and a possible window sash indicated generally by reference 112. In this embodiment of the invention, the window frame 110 and the window sash 112 are each made of wood. A sensor unit indicated generally by reference numerals 118 is inserted into a cylindrical boring 119 in the window sash 112. Instead of being provided in the boring 119 in the window sash 112, the sensor unit 118 could alternatively be provided in a boring in the window frame 110.

The sensor unit 118 has a cylindrical housing 122 having an inner end 124 in the boring 119 and an outer end 126 in the form of a disk forming a peripheral flange 128 around the cylindrical housing 122. The peripheral flange 128 is seated on undersurface 129 of the window sash 112 and, like the flange 28 of FIG. 2, is a thin, so that the sensor unit 118 is almost invisible.

A one-quarter wave wire antenna 132 extends from the cylindrical housing 122 and, in this case, instead of extending longitudinally along the window sash 112, is loosely coiled into a helical shape and accommodated within the boring 112 above the cylindrical housing 122.

A magnet, which is indicated generally by reference numeral 134, and which is accommodated within a cylindrical housing 136, is a likewise embedded in the window frame 110.

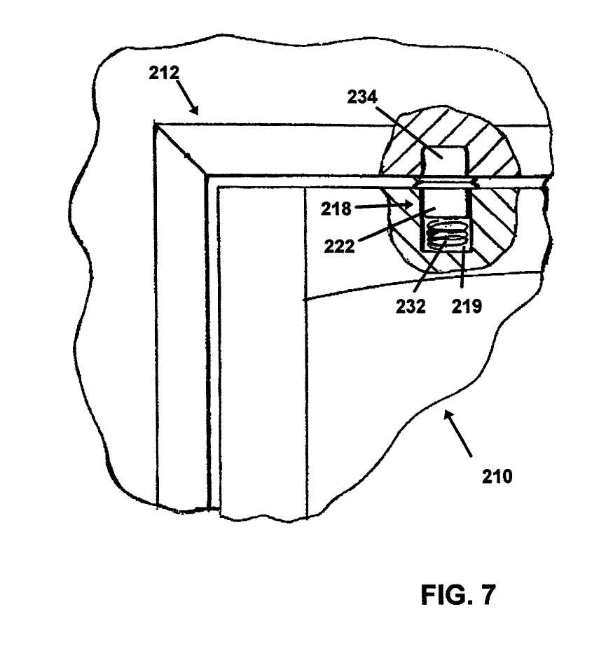

FIG. 7 shows a broken-away view of part of a door 210 in a close position in a door frame 212. In this case, a sensor unit indicated generally by reference numeral 218 is embedded in a cylindrical boring 219 in the top of the door 210, with a wire antenna 132 extending from a cylindrical housing 222 of the sensor unit 218 in a helical fashion beneath the cylindrical housing 222 within the boring 219. A magnet 234 is embedded in the door frame 212 directly above the sensor unit 218

As will be apparent to those skilled in the art, modifications may be made to the above-described embodiments of the present invention within the scope of the invention as defined in the appended claims.

For example, if the sensor unit 18 is installed in a hole drilled in a wooden window sash or door, instead of in a hollow extrusion, the wire antenna 32 can be arranged so as to extend along a surface of the wooden sash or door. In that case, the antenna 32 can be effectively concealed by one or more coats of paint or varnish and/or by being in an inner track of the window frame.

The sensor unit and the magnet may be installed at a factory where windows, doors and their frames are manufactures or may be installed by window and door dealers or on installation of windows and door in their buildings.

1. An wireless security sensor system, comprising;
a pair of members;
said members comprising a frame defining a opening and a closure movable relative to said frame between open and closed positions;
a sensor unit embedded in a first one of said members;
said sensor unit comprising a housing;
said housing having an inner end within said first one of said members, an outer end at a surface of said first one of said members, a wire antenna extending from said housing at the exterior of said housing;
said housing containing a sensor switch, a microprocessor, and RF transmitter and a battery; and
said wireless security sensor system including a magnet mounted in the other of said members for actuating said sensor switch.

2. An wireless security sensor system as claimed in claim 1, wherein said first one of said members comprises a frame formed from an extrusion having a hollow interior and said wire antenna extends along said hollow interior.

3. An wireless security sensor system as claimed in claim 1, wherein said wire antenna comprises a ¼ wave wire antenna.

4. An wireless security sensor system as claimed in claim 1, wherein said housing has a peripheral flange at the outer end thereof, said peripheral flange being seated on said surface of said first one of said members.

5. An wireless security sensor system, comprising;
a window frame defining a window opening;
a window sash movable relative to said window frame between open and closed positions;
a sensor unit embedded in said window frame;
said sensor unit comprising a housing;
said housing having an inner end within said window frame, an outer end at a surface of said window frame and an antenna extending longitudinally of said window frame from said housing;
said housing containing a sensor switch, a microprocessor, and RF transmitter and a battery; and
said wireless security sensor system including a magnet mounted in said window sash for actuating said sensor switch.

6. An wireless security sensor system as claimed in claim 5, wherein said window frame comprises a plastics material extrusion having a hollow interior and said housing has a peripheral flange at the outer end thereof, said peripheral flange being seated on said surface of said window frame.
